(19) United States
(12) Patent Application Publication
(10) Pub. No.: US 2012/0179737 A1
(43) Pub. Date: Jul. 12, 2012

(54) SYSTEM AND METHOD FOR SEARCHING FOR MOBILE DEVICES, AND FOR ESTABLISHING CONNECTIONS AND DATA EXCHANGE BETWEEN THE MOBILE DEVICES

(76) Inventors: Victor Baranov, Toronto (CA); Yuri Sedov, Tomsk (RU); Roman Yakovlev, Tomsk (RU)

(21) Appl. No.: 13/114,378

(22) Filed: May 24, 2011

Related U.S. Application Data
(60) Provisional application No. 61/396,567, filed on May 27, 2010.

(51) Int. Cl. G06F 15/16; H04W 76/02

(52) U.S. Cl. 709/201

(57) ABSTRACT

In accordance with embodiments, there are provided mechanisms for wireless data transfer, and more particularly, to the search of mobile devices, establish connections, and exchange information between mobile devices using cellular communication channels as well as different modes of IEEE 802.11 standard sets. The methods of mobile device connections include establishing direct connections between devices and/or establishing connections via a special server (e.g., when direct connections between devices are impossible, impractical, and/or not convenient).

### CROSS-REFERENCE TO RELATED APPLICATION

The present application claims the benefit of U.S. (Provisional) Application No. 61/396,567, filed May 27, 2010, the contents of which are incorporated herein by reference in their entirety.

### FIELD

The present specification relates to wireless communications. More specifically, the present specification relates to establishing connections between one or more mobile devices during wireless communications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Smart phones, mobile devices that combine the features of mobile phones and computers, are gaining an increasingly important market share in mobile communications. Majority of up-to-date communication models are equipped with built-in global positioning satellite (GPS) navigation systems and are compatible with various standards of wireless communication.

The predominant wireless standard for wireless device communication is the Institute of Electrical and Electronics Engineers (IEEE) 802.11 family of communication standards (such as a, b, g, n—collectively, these IEEE 802.11 communication standards are sometimes referred to as the “802.11 alphabet soup”). The IEEE 802.11 standards, which are also known in the market as Wi-Fi, are used for establishing wireless local area networks (Wireless Local Area Network—WLAN). The IEEE 802.11 standard defines two network modes—Ad-hoc and Infrastructure. The ad-hoc mode (also known as peer-to-peer) is a simple network where the stations (clients) are directly connected to each other without any special access point. The infrastructure mode implies a wireless network with at least one access point and a set of wireless client stations. Wi-Fi zones are established by connecting several access points. A handover function allows users to move between access points within the Wi-Fi coverage area without disconnection.

Advantages of Wi-Fi networks are as follows:

a. Simple and quick network establishment;

b. Possibility of device movement;

c. Scalability;

d. Ad-hoc mode connection between devices is established directly without any access point and is usually free of charge.

A disadvantage of Wi-Fi networks is that WLAN coverage is limited by hotspots of access points or mobile devices (in case of ad-hoc networks). For example, the coverage radius of 802.11g access points and routers depends on the number and types of obstructions, and in case of standard antennas usually does not exceed 160 meters outdoors and 50 meters indoors.

Another type of wireless network is Wireless Wide Area Network (WWAN). Data transfer in WWAN networks is based on wireless cellular communication technologies such as Universal Mobile Telecommunications System (UMTS), General Packet Radio Service (GPRS), Code Division Multiple Access (CDMA2000), Global System for Mobile Communications (GSM), Cellular Digital Packet Data (CDPD), Mobitex, High-Speed Downlink Packet Access (HSDPA), Third Generation (3G), Fourth Generation (4G), Worldwide Interoperability for Microwave Access (WiMax), etc. Advantages of WWAN networks include a wide coverage area defined by coverage areas of a carrier's stations and a possibility of data exchange with external networks, including the Internet. WWAN disadvantages include high cost of Internet services and often low speed of data transfer.

Irrespective of the standards used to establish the search and connection of mobile devices, all connections may be conventionally divided into two types: those in one network segment and those in different network segments. In case of one network segment connection, network nodes transfer information without routing of network packets. Transfer of information without routing of network packets occurs when mobile devices are connected in the ad-hoc mode or directly via an access point. In an event when mobile devices are located in different network segments, data is transferred by routing network packets. In the case of one network segment, the mobile devices may find each other by means of sending broadcast packets, and establish connection and exchange information. In the case where the mobile devices are located in different network segments, the mobile devices may not find and connect with each other directly, and consequently a specialized intermediate server is required.

In light of the foregoing discussion, there is a need for an improved method of connecting mobile devices, irrespective of whether they are in one network segment or in different network segments, which can overcome one or more drawbacks discussed above.

### SUMMARY

Some embodiments of the present invention provide a method for exchanging information between a first computing device and a second computing device, for example, a first mobile device and a second mobile device. The method includes facilitating a user of said first mobile device to select one or more parameters. Thereafter, based on said one or more parameters, a search is carried out among a plurality of computing devices, for example a plurality of mobile devices, to identify one or more mobile devices. The search among the plurality of mobile devices is carried out using either a short-range communication standard, when the plurality of mobile devices are in a network segment that is same as a network segment of the first mobile device or using an intermediate server, when the plurality of mobile devices are in network segments different from the network segment of the first mobile device.

Thereafter, the method includes providing the user with a list of the one or more mobile devices resulting from the search and facilitating the user to select the second mobile device, for exchanging the information, from the list of the one or more computing devices. Subsequently, a connection is established between the first mobile device and the second mobile device for information exchange, using either a short-range communication standard, when the second mobile device is in a network segment that is same as a network segment of the first mobile device or using an intermediate server, when the second mobile device is in a network segment different from the network segment of the first mobile device.

In another embodiment, the invention provides a computer program product that includes instruction for enabling the method of exchanging information between the first computing device and the second computing device.

In accordance with embodiments, there are provided mechanisms for wireless data transfer, and more particularly, for the search of mobile devices, establishment of connections and information exchange between mobile devices using cellular communication channels as well as different modes (e.g., different modes of IEEE 802.11 standard sets), including by establishing direct connections between mobile devices, or by means of a special intermediate server when direct connections between devices are impossible or unreasonable. In this specification, the word device may refer to a user device or terminal, a mobile device or terminal, a mobile phone, a laptop, handheld computer, computer pad (e.g., an iPad®), another mobile device, personal computer, or other similar device.

Embodiments of systems and methods for searching for mobile devices, and for establishing connections and data/information exchange between the first mobile device and the second mobile device. The invention also provides a method of communication establishment and a related communication system based on a universal set of services. The method and system may search for mobile devices, retrieve a list of devices, establish connections and exchange information between the selected mobile devices, irrespective of standards used to establish communication and whether devices are located in one or different network segments.

In embodiments, in an event when mobile devices are located in one network segment, direct network connection is established, and in an event when mobile devices are located in different network segments, an intermediate server, for example a proxy server, is used. The proxy server stores a list of mobile devices registered with the proxy server, along with geographic location of the mobile devices that was communicated by each mobile device at the moment of the mobile device's registration on the proxy server or after a significant movement of the mobile device in physical space or area within the network segment.

Additionally, in embodiments the proxy server may also perform additional functions to ensure interaction between mobile applications including: prioritization of transfer data streams for certain applications, supporting several applications running in one and the same mobile device, searching for applications in a network by parameters specified by the applications, including criteria specified by users of the applications, etc.

In embodiments, following the registration of a mobile device on the proxy server, the mobile device queries the list of mobile devices currently registered on the proxy server and located in a specified geographical proximity from the querying mobile device. Such queries from the mobile device to the proxy server may be sent manually by the user's request or automatically, for example when a user is moving at a great speed and the list of mobile devices located in a given radius is changing quickly, the query process is accompanied by a process of updating on the proxy server the location of the querying mobile device.

In embodiments, following query from the mobile device, the proxy server returns the list of mobile devices, from which a subset of mobile devices from the received list is selected by the user and connections with the subset of mobile devices is established through the proxy server, thereby establishing a communication channel between a connection-initializing mobile device, the proxy server, and the mobile device which was selected for connection from the subset selected at the previous step.

In embodiments, following the establishment of the communication channel through the proxy server, applications installed on the connected mobile devices may start exchanging information irrespective of device connection type. Each mobile device can independently establish many connections, both (1) direct (in one network segment), and (2) through the proxy server when the mobile devices are present in different network segments. The mobile device platform allows simultaneous support of both direct and server-through connections.

Embodiments of the system are configured to allow establishment of information exchange between multi-user applications of any purpose. For example, applications may be used for ad delivery between mobile devices directly, taking into account geographical proximity, for sending streaming data between applications, building social networks, multiplayer games, exchange of files of any type, etc.

As may be seen from the foregoing summary by a person skilled in the relevant art, the system and methods of the present invention provide a universal, multi-channel, secure communications environment for developers of applications targeting mobile devices of any brand/manufacturer and model sufficiently capable of supporting the disclosed features and capable of taking advantage of location and proximity contexts.

Each embodiment disclosed herein may be used or otherwise combined with any of the other embodiments disclosed. Any element of any embodiment may be used in any embodiment.

Any of the above embodiments may be used alone or together with one another in any combination. The communication methods and systems encompassed within this specification may also include embodiments that are only partially mentioned or alluded to or are not mentioned or alluded to at all in this brief summary or in the abstract.

The aspects, features, techniques and advantages of the present invention described herein are not all-inclusive, and, in particular, many additional aspects, features, techniques and advantages will be apparent to one of ordinary skill in the art in view of the figures and the following description of the preferred embodiments of the present invention.

The foregoing is a summary and thus contains, by necessity, simplifications, generalizations, and omissions of detail. Those skilled in the art will appreciate that the summary is illustrative only and is not intended to be in any way limiting.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a flowchart of an embodiment of a method for searching for mobile devices within a single network segment;

FIG. 2 is a flowchart of an embodiment of a method for server-assisted search for mobile devices in different network segments;

FIG. 3 is a flowchart of an embodiment of a method for establishing a network connection within a single network segment;

FIG. 4 is a flowchart of an embodiment of a method for establishing a network connection with a proxy server;

FIG. 5 is a flowchart of an embodiment of a method for conducting data transfer between mobile devices;

FIG. 6 is a flowchart of an embodiment of a method for conducting data transfer within a channel;

FIG. 7 is a flowchart of an embodiment of a method for performing channel opening on a mobile device side;

FIG. 8 is a flowchart of an embodiment of a method for performing channel opening on proxy server side;

FIG. 9 is a flowchart of an embodiment of a method for conducting a server-side data transfer into a channel;

FIG. 10 is a block diagram of an embodiment of a subsystem of services interoperability;

FIG. 11 is a flowchart of an embodiment of a method for performing initial loading of services;

FIG. 12 is a flowchart of an embodiment of a method of operating a configuration service;

FIG. 13 is a flowchart of an embodiment of a method of operating a location subsystem;

FIG. 14 is a block diagram of an embodiment of settings for a mobile device;

FIG. 15 is a flowchart of an embodiment of a method for handling of a request for initial connection from an application within the system;

FIG. 16 is a flowchart of an embodiment of a method for handling of channel data transfer;

FIG. 17 is a flowchart of an embodiment of a method for generating a request for an initial connection with the system on the application side;

FIG. 18 is a flowchart of an embodiment of a method for handling of a search request for mobile devices by the application property service; and

FIG. 19 shows a block diagram of an embodiment of a device used in this specification.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Before describing the present invention in detail, it should be observed that the present invention utilizes a combination of method steps and apparatus components related to a method of establishing a connection between two mobile devices and facilitating information exchange between the two mobile devices. Accordingly the apparatus components and the method steps have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

It will be appreciated that embodiments of the invention described herein may include one or more conventional processors and unique stored program instructions that control the one or more processors to implement, in conjunction with certain non-processor circuits, some, most, or all of the functions of communication between mobile devices described herein. The non-processor circuits may include, but are not limited to, a radio receiver, a radio transmitter, signal drivers, clock circuits, power source circuits, and user input devices. As such, these functions may be interpreted as steps of a method to enable communication between mobile devices. Methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention provide a system, a method and a computer program product that enables searching for mobile devices, and for establishing connections between one or more mobile devices and data/information exchange between connected mobile devices. The invention also provides a method of communication establishment and a related communication system based on a universal set of services. The invention allows searching for mobile devices, retrieving a list of mobile devices, establishing a connection between selected mobile devices and exchange information between the selected mobile devices, irrespective of standards used to establish communication and whether devices are located in same or different network segments.

In the description terms devices, mobile devices may be interchangeable used for describing computing devices. Similarly, terms like server, proxy server may be interchangeably used for describing the intermediate server.

In accordance with embodiments, there are provided methods of establishing a network and for corresponding systems that allow the use of short range communications standard, for example wireless communication (Wi-Fi, ad-hoc) modes at short distances between devices. Furthermore, embodiments provide methods for establishing connections, for instances when wireless communication between devices is not possible, through establishment of communications through a special system component, for example an intermediate server, using communication protocols provided by the device.

In embodiments, a unit of the system implementation is a mobile device—a combination of software built for a particular hardware platform (for example, a smart phone, a pocket PC, etc.) supporting a given set of functions. Each function, which may be implemented in a mobile device, may be executed as a subsystem (such as a service). A set of subsystems may be united by a common runtime environment and a common mechanism of data transfer between services. The common runtime environment enables developers to enhance the functionality of a mobile device without changing the overall architecture of the mobile device.

In embodiments, a unit of information that may be transferred between services is a message or an event. Every event comprises information on the status of the subsystem or active operation. In embodiments of the system, a set of outgoing events (events generated by the transferring service) and a set of incoming events are defined for every service. If an event is marked as incoming for some system, then the event should be processed in this subsystem. Outgoing events from some services are at the same time incoming events for other services.

In embodiments, rules of incoming message processing are defined by the internal state of a service and may vary greatly. For example, a request to connect to a remote mobile device may be accepted if the service providing this connection is in its working state, or is rejected if the service is just starting. Thus, from a formal point of view, each service is some kind of a finite state machine with fixed incoming and outgoing alphabet or vocabulary. In other words, each finite state machine “understands” just the events from a fixed, limited “vocabulary” or “alphabet” that makes up the communications protocol for that service.

In embodiments, each mobile device within a network includes at least the following as a standard set of services (subsystems):

a. a service interaction subsystem;

b. a service configuration subsystem;

c. a current device position retrieval subsystem;

d. a connection management subsystem;

e. a subsystem for receiving/transferring information from/to a specified device;

f. a subsystem for detection of devices located at a given distance from the specified device and controlled by applications from a given set;

g. an application interaction subsystem;

h. a subsystem for searching for devices by a given set of application properties.

### Service Interaction Subsystem

In an embodiment, a purpose of the service interaction subsystem is to ensure interaction between mobile device services. A data packet that may be referred to as an “event” is a unit of information exchange between services. Events may be published by subsystems and may include a notification of the subsystem changing states or of the subsystem completing some operations. An event queue may be used for the distribution of events between services.

In embodiments, every event has an identifier describing the service the event originated from and the type of data the event refers to. This identifier may serve as an event type identifier. The identifier allows for associating a processing function with certain types of events. The system uses a subscription mechanism for connecting functions to event types.

The subscription mechanism may be represented by a table with two columns. One column contains the event identifier and the other column may contain the identifier of the service interested in processing the event. The rows may represent subscriptions. Subsystems interested in processing the events may subscribe to the events by simply adding rows to the subscription table. The interaction service transfers an event from the common queue to the corresponding subsystem in accordance with subscription parameters.

In embodiments, the functions of the event processing subsystem includes at least:

a. an event publication by some service;

b. a search for services interested in processing the event;

c. an event transfer to the service;

d. adding/removing the service processing a specific event.

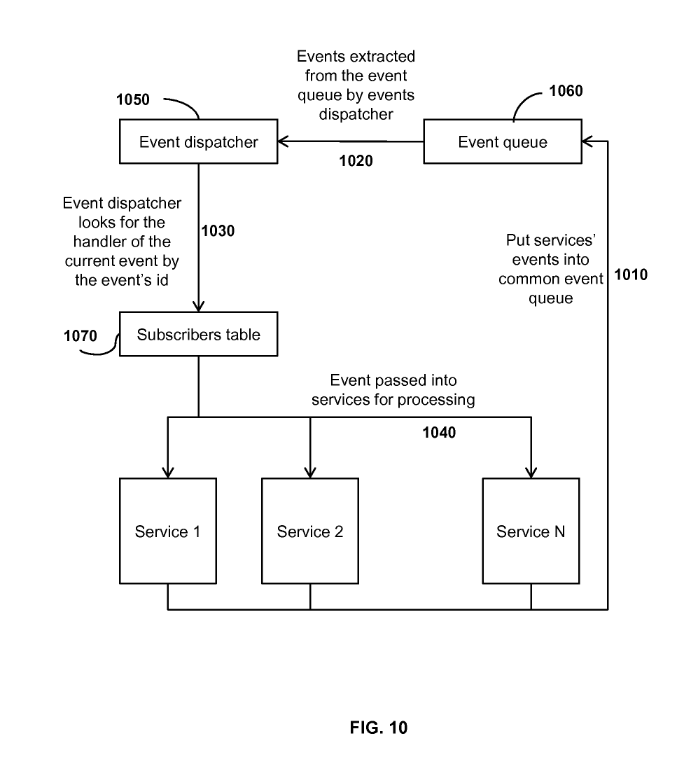

FIG. 10 is a flowchart of an embodiment of subsystem of services interoperability. FIFO (First In-First Out) memory area (1060 in FIG. 10) is meant for storage of a certain subset of events, and may be used as a mechanism of event publication and storage. Every service may put an event in the FIFO memory area. Events are selected and distributed among processing services by block 1050 in FIG. 10. Subscription data is represented by a table (1070 in FIG. 10), where one column contains identifiers of processed events and the other column contains names of services and handlers interested in processing these events. An arbitrary number of handlers may be registered for one event. Each system service may add itself to the list of handlers and remove itself from the list of handles. In an embodiment, one event may be processed by the following method (which is described in FIG. 10):

1. At step 1010, an event is created in one of the services and added to the event queue (1060). This action may be carried out as many times as necessary by various services.

2. The event dispatcher (1050) monitors the queue. If the queue is not empty, the next event is extracted from it. This is shown as step 1020 of FIG. 10. Events are extracted from the queue in the same order as they were put into the queue according to the FIFO principle.

3. Subsequently the event dispatcher looks for a handler of the current event at step 1030. At this step, the event dispatcher extracts event identifier from the event and starts to search table 1070 for the rows containing the current identifier in the first column. The value in the second column of such a row is to contain the identifier of the service processing the event.

4. A copy of the event is transferred to every service found by implementing steps 2 and 3, above. The copy transfer is shown in FIG. 10 under step 1040. Following the event transfer, the event is deleted since the event transfer processing cycle is over.

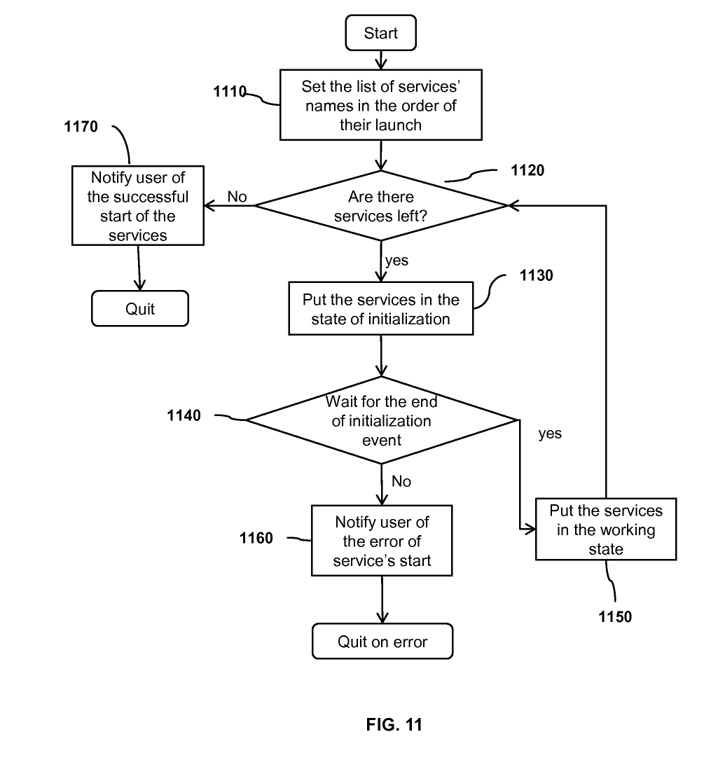

In an embodiment, proper system performance is generally based on proper interaction between services. From the perspective of proper interaction between subsystems, the order of subsystems starting and stopping is very important for smooth system performance. In addition, a flexible mechanism for starting subsystems allows for the use of only the necessary set of services in every session or for the use of fewer subsystems than were the flexible start not available. The use of fewer subsystems, in turn, allows for a reduction in overall power consumption of the system and an increase in system performance. An embodiment of one of the possible system action procedures is illustrated in FIG. 11 as follows:

1. At the first step 1110, the service interaction subsystem downloads a list of service identifiers. The list of service identifiers indicates both the set of services for a session and the order in which the services start. The list may be defined both by system settings and launch parameters.

2. In the event there are still non-processed service identifiers in the list, then at step 1120, the next service identifier is read. If all the service identifiers of the list of services are processed, it is considered that the system was started successfully.

3. An event that initiates the currently started service is sent, and the system waits for a message from the service about the completion of the first step at step 1130. The initialization completion message may contain an error code. If an error occurred, the system start is considered unsuccessful, and the method terminates. Otherwise, the method returns to step 1120. The initialization completion message may also be referred to as an initialization completion event, and is a message or event that indicates the completion of the initialization process. In an embodiment, if the service associated with just one service identifier fails, the method quits creating an initialization error. Services that are tolerant to certain errors do not report them as errors, such as initialization errors, but rather are reported (and treated) as warnings. In case of a warning the method continues to run. An initialization error is a critical error, so the process execution cannot continue. In other words, services may include instructions that determine whether a certain error is to be treated as critical (terminating the process) or not. As an example, if a service tries to establish a connection and the attempt to establish the connection fails, the service may not report the failed attempted connection as an error, because the service can try to establish the connection again, later on. On the other hand, a service not being able to allocate enough memory for the data needed by the service may be considered to constitute a critical error, the process execution does not make sense, and so should the service may be terminated.

The method illustrated in FIG. 11 assumes that the order in which services start is already preset when the system is initialized. Each service is initialized independently. The subsystem is started only when the initialization procedure is over. The subsystem starts after the initialization procedure concludes, which allows for the optimization of the service operation in accordance with mobile device capabilities and the available network environment.

### Services Configuration Subsystem

The services configuration subsystem stores the settings of all other services and the services configuration subsystem is used to initialize the settings of the services both when the system is started and when it is running. The services configuration subsystem may also be used for information exchange between the subsystems of a mobile device. The primary functions of the services configuration subsystem service may be summarized by the following list:

a. Addition of a system settings parameter;

b. Removal of a system settings parameter;

c. Modification of a previously created system settings parameter;

d. Request for the current value of settings parameters.

Table 1 is a possible embodiment services configuration subsystem in tabular form with the following columns: parameter name, parent parameter name, and parameter value. The value and name of each parameter represents a row. The organization of parameters in the list allows for arranging hierarchical structures of a system service settings representation.

TABLE 1

| Parameter name | Parent parameter name | Value |
|---|---|---|
| “System” | “” | “” |
| “Configuration Service” | “System” | “” |
| “Debug level” | “Configuration Service” | “low” |
| “Stop condition” | “Configuration Service” | “error” |
| “Log filename” | “System” | “tmp.log” |

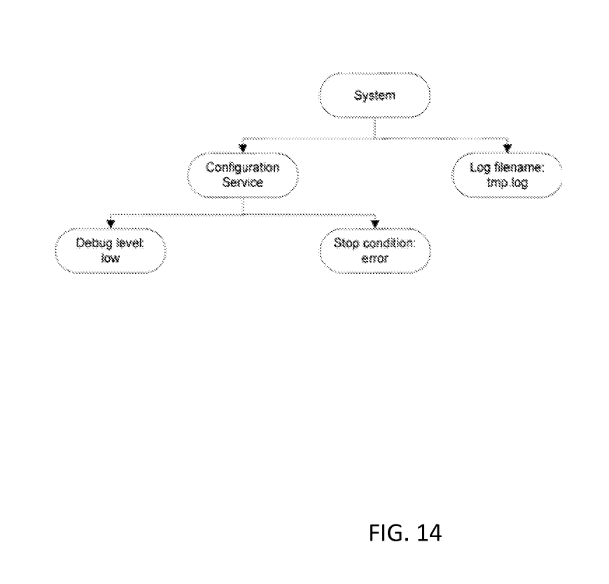

The settings table fragment of table 1 illustrates the hierarchy of parameters shown in FIG. 14.

In the embodiment, the full parameter name may be described as a succession of names from the very top of the tree to the node that corresponds to this parameter, for example “System/Configuration Service/Stop condition.”

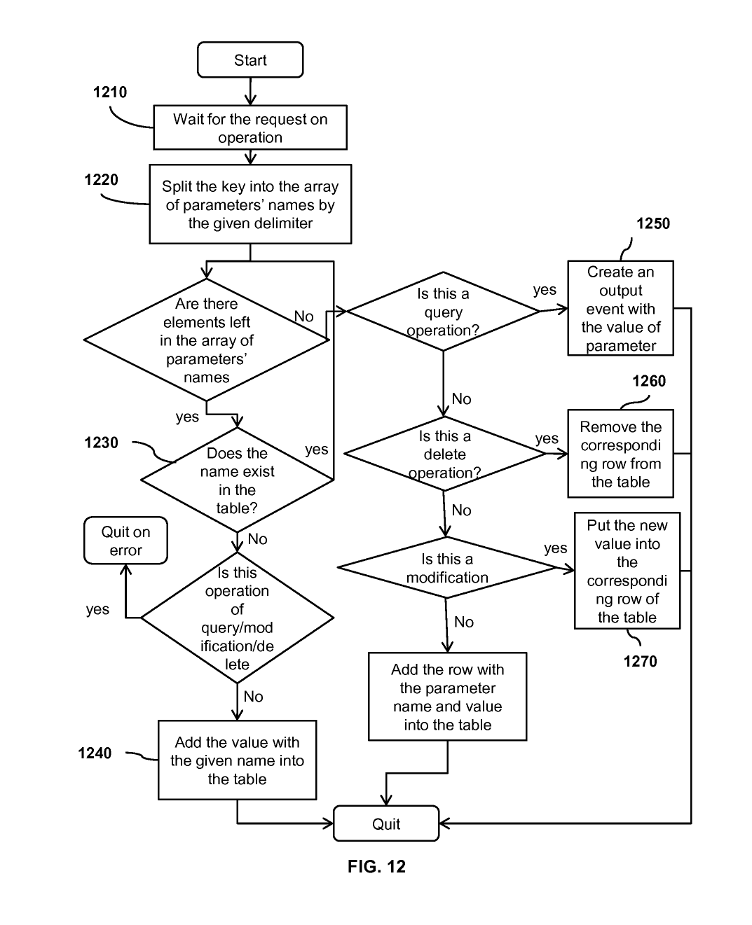

An example of an embodiment of a possible configuration service operation method is illustrated in FIG. 12. In this method, it is assumed that all events coming to the service describe one of the above actions and contain the parameter name. Parameter modification and addition queries also contain the argument value. It is assumed that in one of the possible embodiments of the system the full parameter name is set in the above format. In this case:

1. The first step of the configuration service operation method comprises waiting for queries for one of the above operations illustrated in table 1. This step is illustrated in FIG. 12 under step 1210.

2. In the event a query is received, a subset of the names the parameter is composed of is extracted from the full name of the parameter in the order the subset of names follow each other in the full name of the parameter at step 1220.

3. The obtained array of names is searched through. If the array is over, the process passes to step 1250. Otherwise, a search is carried out for the next row in the table of the rows that contain it in the “Parameter name” column at step 1230.

4. If the sought-for row is not in the table, then at step 1240, the type of operation required to be carried out by the processed message is checked. If the required operation is the parameter addition operation, then the corresponding row is added to the table, and the process passes to step 3 here. For processing of all other operations, if the row is not in the table, it means the parameter name is wrong. The method generates an error message and terminates. If the row is in the table, then the operation is passed to step 1230.

5. The type of the operation requested in the event is analyzed, and the corresponding action is carried out. In the event a value query was received, then the event with the value of the queried parameter is returned at step 1250. In the event it is a parameter deletion operation, then the last found row is deleted from the table at step 1260. A value modification query leads to the change of the corresponding row in the table of parameters. Creation of a new parameter leads to addition of a row. All of these actions are considered successful termination of the service.

### Current Device Position Retrieval Subsystem

The current device position retrieval subsystem obtains the current position of a mobile device using the mobile device's built-in GPS/A-GPS (Global Positioning System/Assisted GPS) features. The current position of a mobile device is defined by the mobile device's geographical latitude and longitude, altitude above sea level and location accuracy. Initially, the current position may be defined by a deliberately incorrect value (for example, all position fields take the value of −1).

In an embodiment, the mobile device position acquisition requires a significant amount of time, is a power-intensive operation, and raises privacy considerations; therefore this subsystem is usually started upon the user's explicit permission. In intervals between the current location acquisition queries, the subsystem returns the position retrieved for the latest query. Thus, the primary functions of the current device position retrieval subsystem include at least:

a. a request for current device position, from cache; and

b. a request for acquisition of new device position, using GPS/A-GPS hardware and services.

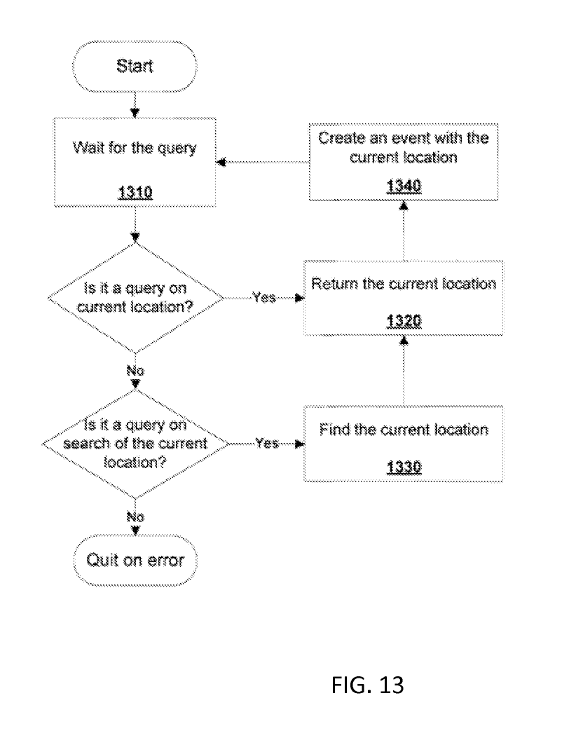

The current device position retrieval subsystem operation method is illustrated in FIG. 13 as follows:

1. When the current device position retrieval subsystem is in a running state, the service waits for an event to process at step 1310. In this moment, the subsystem obtains the values of the current device location. These device location values may be calculated in advance or contain deliberately incorrect values as described above.

2. After the event is received, its type is analyzed at step 1320. If the event contains a query for the current location, then the process passes to step 1340. If the event contains a query for the new location of the device, then the process passes to step 1330. If the query does not belong to the processed type, an error is generated.

3. The identification of a new location of the device may use the built-in GPS/AGPS features of the mobile device at step 1330. However, the locating operation may take a lot of time, and the locating event may contain limitations of time or limits of the required or desired accuracy. The limitations of the locating event may be processed in the procedure of location identification in different ways depending on the chosen platform. For example, a GPS-navigation system running under the Windows Mobile platform may consistently return the refined location in the process of acquisition, so that the service can meet the parameters of the incoming query by choosing the first location value meeting accuracy limitations or the last value retrieved during the period specified by the query.

4. The current location stored in the service is returned to the system by means of an event mechanism at step 1320. After the return of the current location, the method passes to step 1310 above.

In embodiments, mobile device location data may be used both for information exchange with other mobile devices and for device registration on the server component.

### General Method of Communication Establishment Used in the System of the Present Invention

In an embodiment, the system may require information transfer to another mobile device equipped with the same system. A special feature of embodiments of the information transfer method is that the receiving/transmitting procedure remains unchanged regardless of the system operation method. Existing methods of transferring data through a specialized server differ significantly from direct data transfer between devices, i.e., in other words, methods of transferring data between mobile devices present in the same network segment differ significantly from method of transferring data between mobile devices present in different network segments. However, embodiments of the present invention include methods that eliminate the differences between direct transferring of data from one device to another and server-assisted transferring of such data. In other words, the transfer method is kept the same on the device side, regardless of whether connection is peer-to-peer or proxy-server based—the difference in topology of the connections is accounted for and/or has no effect.

Furthermore, a distinctive feature of some embodiments is a method of data transfer between devices (irrespective of connection establishment method) by means of temporal multiplexing of channels. The mechanism of channel multiplexing is used to prioritize various data types transferred between mobile devices. In temporal multiplexing, numerous open channels may simultaneously exist between two mobile devices that are temporally multiplexed into one physical TCP/IP protocol connection.

In the embodiments, each channel between two mobile devices has three identifiers: a channel number on a sender's side (a second mobile device), a channel number on a receiver's side (a first mobile device), and a unique channel identifier. For data transfer into the channel, it is necessary to specify the sender's mobile device identifier and the receiver's channel number, since, as stated above, each mobile device may simultaneously have many active channels with each of the available mobile devices. The unique channel identifier serves to define channel data type, and the unique channel identifier is used only at the moment of channel opening.

Temporal channel multiplexing, in the embodiments, is carried out by means of a data transfer windows mechanism. The data transfer windows mechanism implies that each channel is associated with a certain data size named a window. A mobile device may transfer data to the channel only if the size of the transferred data does not exceed the size of the window. In the event the size of the transferred data becomes equal to the size of the window, the sender has to stop data transfer through the active channel. The data transferred in excess of the size of the window will not be processed by the receiver.

Furthermore, in order to continue data transfer using the current channel, the sender waits for a message from the receiver about the window's size increase. After such a message is received, the size of the window is considered increased by the value specified in the message, and the sender may resume data transfer. Thus, in the event, that the connection has several channels, data transfer priority in each channel may be managed by controlling window sizes of each channel as needed.

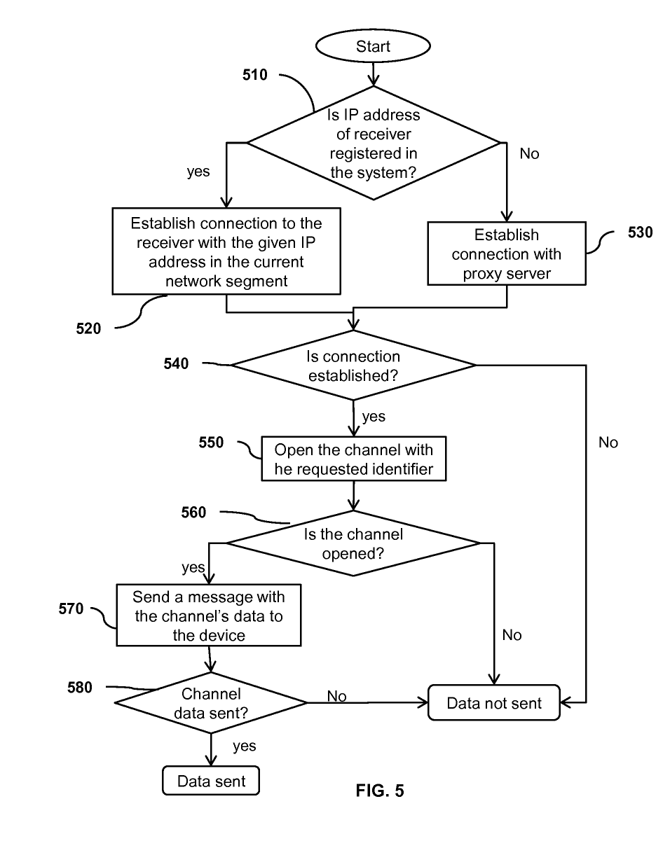

FIG. 5 illustrates a general method of an embodiment for data transfer between two mobile devices. In FIG. 5 the data transfer process is as seen by the active mobile device, i.e. the first mobile device initiating this data transfer:

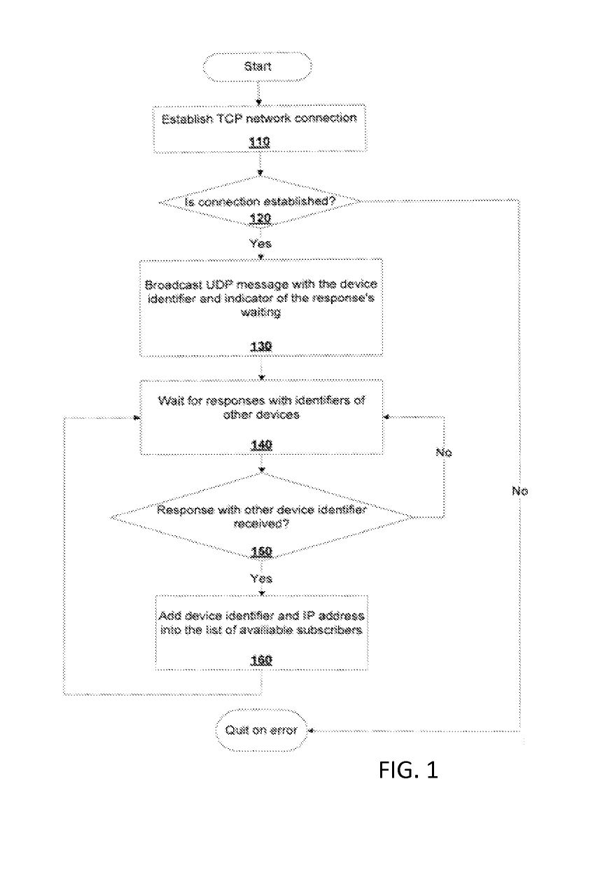

1. Data transfer starts with the establishment of a connection between mobile devices. For establishing a connection, at step 510, a verification is performed to verify whether the IP address for the receiver (the first mobile device) is registered in the system. In the event the address is registered, a connection with mobile device of the receiver should be established directly, without any intermediate server, since the mobile devices of the receiver and the sender are in the same network segment, which follows from step 110 in FIG. 1. If the IP address is not registered in the system, the connection should be established through the intermediate server.

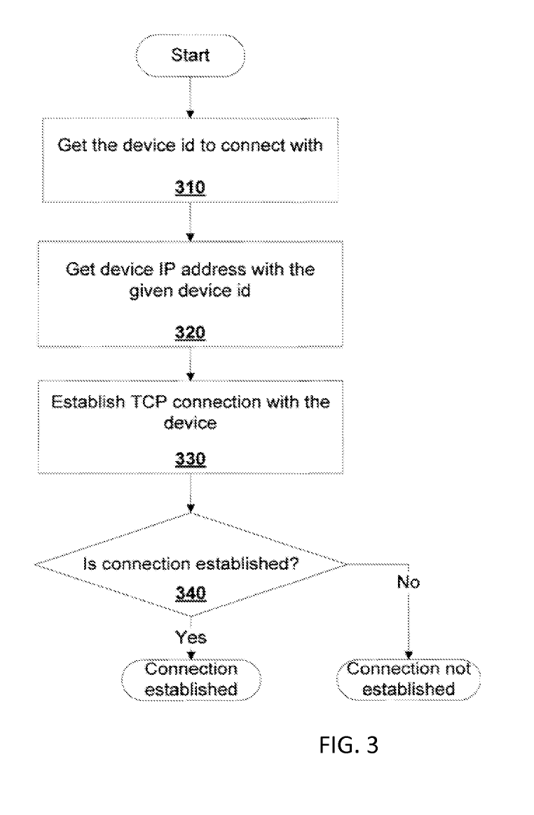

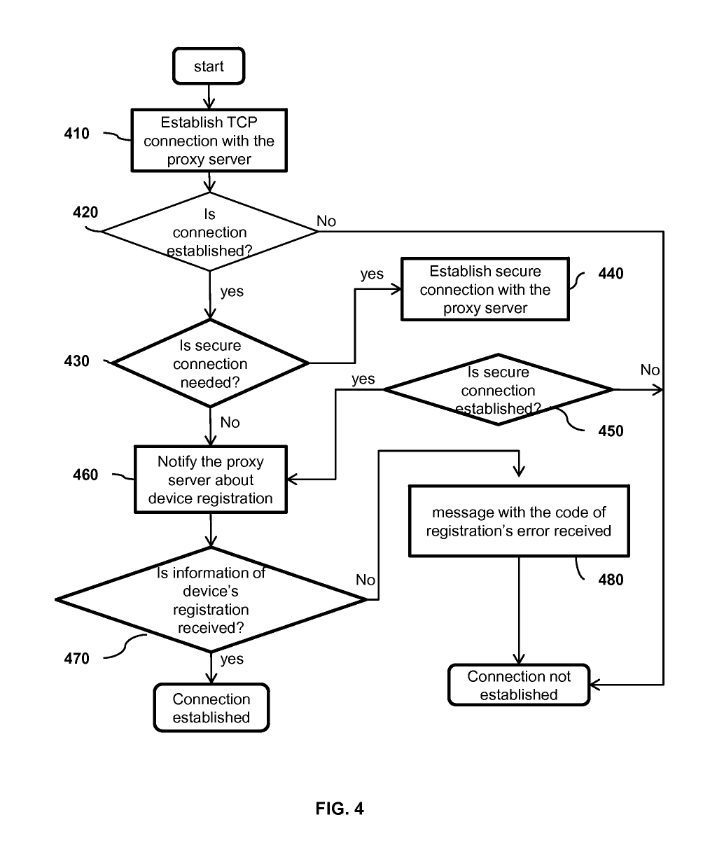

2. Steps 520 and 530 indicate the establishment of a direct connection and server-through connection, respectively. The establishment of a direct connection is described in FIG. 3, and of a server-through connection in FIG. 4.

3. Each of the connection establishment methods may terminate successfully or unsuccessfully, which is verified at step 540. In the event the connection establishment method is terminated with an error, no data may be transferred between the mobile devices, and as a result, the establishment method illustrated in FIG. 5 terminates. Otherwise, it passes to step 550.

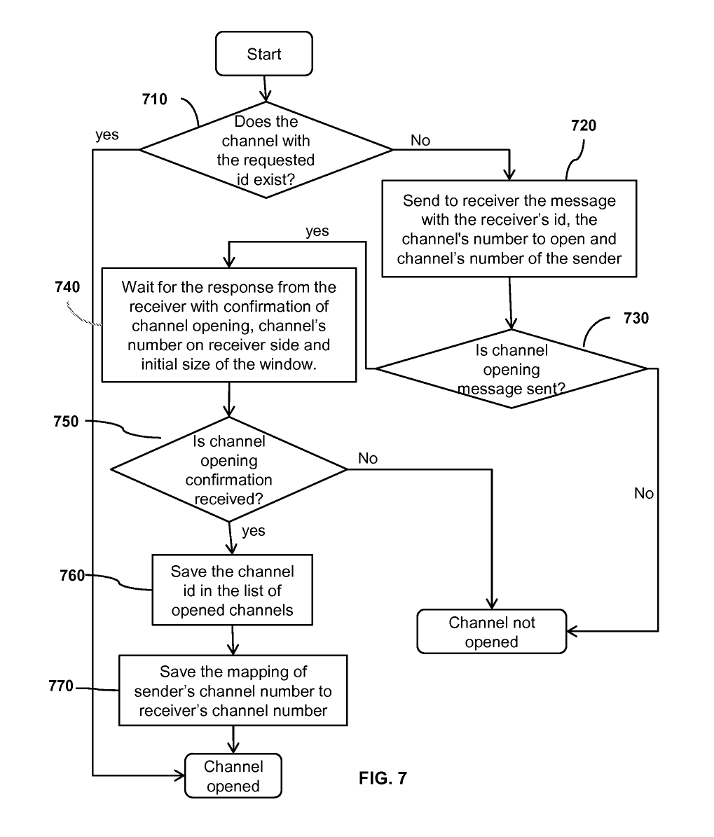

4. At step 550, the establishment method opens a new channel between the devices. The establishment method of a new channel opening is illustrated in detail in FIG. 7. It should be noted that FIG. 5 illustrates a method of data transfer between mobile devices that were not connected earlier. If at the moment of data transfer both mobile devices were connected before, the method passes directly to step 550. A condition may arise in the described system that a device may initiate data transfer to an already existing channel. In the case of initiation of data transfer to an existing channel, the method at step 550 will not open a new channel as shown in FIG. 7, but will use the already opened channel instead.

5. Starting from step 550, regarding establishing the method, it does not matter whether the devices are located in one network segment or are connected through a server. The only difference for the software system is the IP addresses of devices, i.e., in case of server-through connection it is the IP address of the server that is used as the IP address of the mobile device of the receiver.

6. In the event a channel is opened successfully, which is verified at step 560, the mobile device starts to transfer data between devices. If at step 560, it is determined that a channel cannot be opened, the data cannot be transferred and the method illustrated in FIG. 5 terminates with an error.

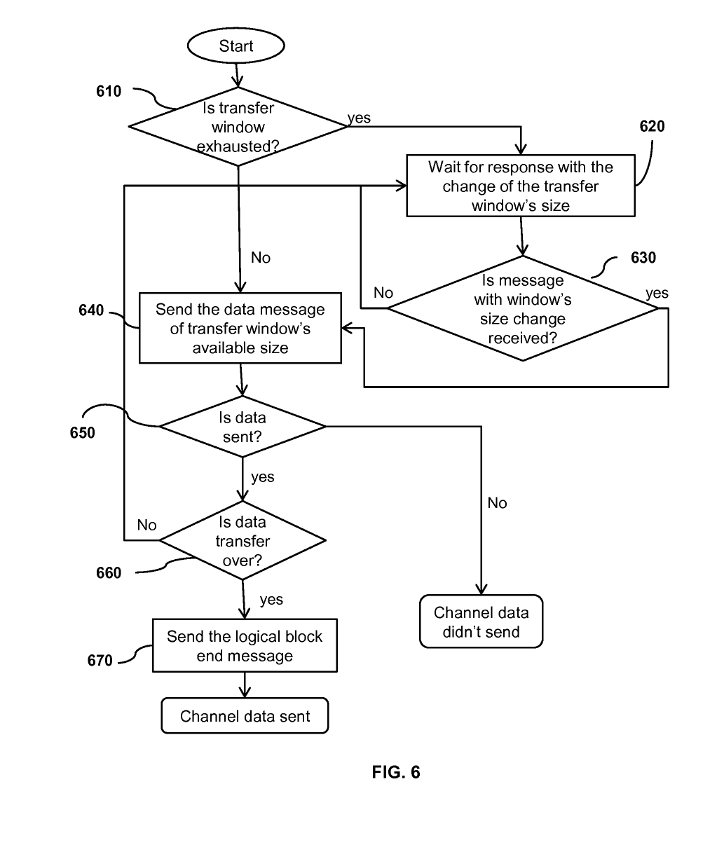

7. Channel data transfer occurs at step 570, and is illustrated in FIG. 6.

FIG. 6 is a flowchart of an embodiment for conducting data transfer within a channel.

The connection establishment method of FIG. 5 includes at least the following tasks:

a. An establishment of a connection between devices within one network segment (FIG. 3);

b. An establishment of connection between devices through a server component of the system (FIG. 4);

c. Opening of a new communication channel for information transfer (FIG. 7);

d. The transferring of data between devices (FIG. 6).

The above tasks do not necessarily need to be implemented by one service. In particular, in the embodiment under consideration, the connection establishment task is assigned to the connection management subsystem, and the opening of a new channel and data transfer between devices—to the information receiving/transferring subsystem. Methods for these tasks will be disclosed further in the sections dedicated to the corresponding subsystems.

### Network Connection Establishment Subsystem

The embodiment of the network connection establishment subsystem establishes a network connection using one of the protocols implemented in a mobile device. A feature of the network connection establishment subsystem is a method of formalizing the network connection process. Formalizing the network connection process allows for implementing a network connection irrespective of the platform used. The network connection establishment subsystem may be used both to establish a connection in a given network segment, and for a connection through a server component of the system.

FIG. 3 is a flowchart of an embodiment for establishing a network connection within a single network segment as follows:

1. At step 310, the method receives an incoming parameter in the form of a device identifier of the first mobile device with which the connection is to be established.

2. Using the specified device identifier, at step 320 the second mobile device receives the IP address of the mobile device with which the connection is to be established. This IP address was stored in the system at step 160, FIG. 1.

3. Using the IP address received at step 320, at step 330 the first mobile device attempts to establish TCP/IP protocol connection with the required mobile device.

4. At step 340, it is verified whether the connection initiated at step 320 was successful. Depending on the result of step 340, the method terminates either successfully or with an error.

FIG. 4 is a flowchart of an embodiment for establishing a network connection with the proxy server as follows:

1. At step 410, TCP/IP protocol connection is established with the proxy server.

2. If the connection is established successfully, which is verified at step 420, the method passes to step 430 at which the necessity to establish secure connection is checked. Otherwise (if connection verification at step 430 failed), connection with the server is considered not established.

3. A requirement to establish a secure connection may be specified in the connection establishment query. In the event a secure connection is specified, the method passes to step 440 of secure connection establishment. In the event a secure connection is not required, the method passes to step 460.

4. The secure connection is established using the TLS (Transport Layer Security) method described in the IETF (Internet Engineering Task Force) RFC (Request For Comment) 2246 document.

5. At step 450, it is verified whether the secure connection is established. The criterion for the secure connection establishment is an error-free termination of the method described in the IETF RFC 2246 document. Connection security level (encryption method, authenticity of parties' certificates and other parameters of secure connection according to IETF RFC 2246) are not taken into account.

6. If after step 450 a secure connection is not established, the method terminates and connection with the server is considered not established. Otherwise, the method passes to step 460.

7. At step 460, the method sends a specifically structured message using the established connection (secure or open, depending on the results of steps 430 and 450). The specifically structured message may include a message identifier and a mobile device identifier, as well as mobile device characteristics used by the proxy server for more accurate identification of the mobile device. The message identifier is an integer that identifies the purpose of the current message and registers the mobile device on the proxy server. The mobile device identifier is used to identify the mobile device on the server. In one embodiment of the invention, the device identifier is a string of 16 symbols that uniquely identifies the mobile device among all others.

8. After step 460, the method waits for a response from the server to the message sent at step 460. The response to this message may be either a message about successful registration on the server, which is processed at step 470, or a server error message, which is processed at step 480.

9. At step 470, the method terminates and connection with the server is considered successfully established. At step 480 or in case no response is received from the server within a given period, connection with the server is considered not established.

Irrespective of the chosen connection establishment method, the result of the connection establishment subsystem operation is the establishment of a connection with the network. This connection may be used for information transfer between devices. The system may include a special service for this purpose.

### Subsystem of Information Transfer to a Specified Device

The purpose of the embodiment of the subsystem described next is to establish an information transfer channel between two specified mobile devices, and transfer of data using this channel. A channel implies a logical connection between information sender and receiver. As stated above, an information transfer channel is created within a previously established network connection. The subsystem uses the principle of temporal multiplexing of communication channels within a previously established network connection. Information transfer channels in the present system are created by a single method irrespective of whether they are located in one network segment or in different network segments.

FIG. 7 illustrates a method for opening a channel between two devices. Since each device may have multiple channels with each of one or more available devices, each channel is numbered on two sides: the side that initiates channel creation, and the side that receives the channel.

1. When an attempt to open a channel between devices is made, it is verified at step 710 whether there is already an existing channel with this unique identifier. If such a channel already exists, the channel opening method terminates successfully.

2. Otherwise, the method passes to step 720 to send a message to the receiver; the message may contain the receiver's mobile device identifier, the sender's channel number, and the unique channel identifier.

3. In the event this message is sent successfully, which is verified at step 730, the method passes to step 740 to wait for the channel opening confirmation from the receiver. Otherwise, the method terminates with an error.

4. In the event a message is received from the receiver to confirm a channel opening, which is verified at step 750, the method passes to step 760 to save the unique channel identifier in the list of opened channels, and further to step 770 saving the mapping of sender's channel number and receiver's channel number.

5. Following step 4 above, the channel is considered opened and ready to receive data, and the channel opening method terminates successfully. The channel opening confirmation message may also include the size of the initial channel data window, which is used in the method of channel data transfer (FIG. 6).

6. If at step 750 the channel opening confirmation message is not received, the method terminates with an error.

Following a successful channel establishment, devices may start data transfer in accordance with the general method of data transfer (FIG. 5). The method of data transfer between devices is described as follows and is shown in FIG. 6

1. At step 610, the sender verifies that the window size for the active channel is not exhausted. If the window size is exhausted, the method passes to step 620 to wait for a message from the receiver indicating an increase of the data transfer window for this channel. Otherwise, the method passes to step 640 of channel data transfer.

2. Channel data transfer is carried out by sending a specially structured message containing the receiver's device identifier, the receiver's channel number, and channel data number. It may occur that the total amount of channel data to be sent exceeds the size of the active channel window. In the event the amount of data to be sent exceeds the size of the active window channel, the sender sends the amount of data limited by the window size. After this, the sender has to wait for a message indicating the increase of the window size (steps 620 and 630) in order to resume data transfer.

3. In the event the channel data limited by the size of the window is successfully transferred, which is verified at step 650, and the message indicating the increase of the window size is received, the device resumes channel data transfer. Steps 1, 2 and 3 are repeated until all channel data is transferred, which is verified at step 660. If all data is transferred, at step 670 the sender sends to the receiver a channel data logical end message.

4. If at step 650 another portion of channel data cannot be transferred, the method terminates with an error. After step 670, the method terminates successfully.

In case the channel data transfer method illustrated in FIG. 6 terminates successfully, the general method of data transfer between devices illustrated in FIG. 5 also terminates successfully after step 580. Otherwise, the method of FIG. 5 terminates with an error.

An advantage of the described method of data transfer is that data can be transferred irrespective of whether the devices are in one network segment or in different network segments. Server operation in the process of channel creation and data transfer is disclosed in the corresponding section.

### Subsystem of Detection of Devices Located at a Given Distance from the Specified Device and Controlled by Applications from a Given Set

The embodiments of the detection subsystem search for mobile devices located within a given distance from the searching device, where the mobile devices are controlled by applications from a given set. The present subsystem comprises two possible search procedures depending on the system operation method.

The procedure for searching for mobile devices in different network segments implies the use of a server component. In the case where mobile devices are located in different network segments, the subsystem sends a query to the server and waits for the results of this query.

In the event a mobile device searches within the network segment it is located in, the subsystem searches for devices by sending a broadcast query. Subsequently, the subsystem waits for responses to this query for a certain period of time, and the list of device addresses retrieved via the responses to the query are returned in the form of search results.

Irrespective of the chosen method of network connection, the sent broadcast query may include the following: an identifier of the querying mobile device, a list of identifiers of applications that are to run on the sought-for devices, and a maximum distance between the sought-for devices and the querying device. A possible response may be in the form of a feedback including the identifier of the mobile device, the list of identifiers of applications running or installed on the mobile device from amongst those indicated in the query, as well as sets of properties associated with the applications. Each property may be represented, for example, as a “parameter name—parameter value” string. The purpose and use of this set of strings are described below.

One purpose of including these two methods in the system is to provide the user with a constant set of functions irrespective of which method of network establishment is used.

### Detection of Mobile Devices within One Network Segment

The following method may be used to detect mobile devices equipped with the system described below and located in one network segment, i.e., accessible without routing of network packets. The method includes at least the following:

1. At step 110, a physical connection is established between the first computing device with the network segment. Thereafter a search for one or more computing devices from amongst a plurality of computing devices is carried out based on one or more parameters selected by a user of the first computing device. A physical connection is established using a short-range communication standard, for example, an IEEE 802.11 family protocol, while in infrastructure mode (when there is an access point operating under the IEEE 802.11 protocol in infrastructure mode) or ad-hoc (peer-to-peer) mode. Network parameters (namely, IP address, subnet mask, primary gateway, Domain Name System (DNS) server) are assigned automatically. In case a DHCP (Dynamic Host Configuration Protocol) runs in this network segment, the above network parameters are assigned by the DHCP server. In case there is no DHCP server running in this segment, these parameters are assigned based on the APIPA (Automatic Private IP Addressing) technology implemented using standard mobile device functions. With no DHCP server running in the segment, mobile devices usually receive IP addresses from the 169.254.0.0/16 subnet. Thus, all mobile devices connected to this network segment are on-link and can exchange data using the TCP/IP (Transmission Control Protocol/Internet Protocol) protocol without routing of packets.

2. At step 120, verification is made of whether the connection established at step 110 is successful. In case of success, at step 130 the mobile device sends to this network segment a specifically structured broadcast message (i.e., message addressed to all devices connected to this network segment) using the UDP (User Datagram Protocol) protocol. The specifically structured broadcast message may include the message identifier and all of the above feedback fields. The specifically structured broadcast message indicates to the mobile devices already connected to this network segment that a new mobile device is available for connection. The specifically structured broadcast message also contains an indicator of the response that is waiting. Response messages are sent only if the response waiting indicator is set in the original message. After the response message is sent, a newly connected device switches to the mode of waiting for the above structured response messages, thereby enabling a determination of which mobile devices meet the search criteria and are located in this network segment.

3. If it is impossible to establish connection at step 110, the mobile device cannot search for mobile devices in this network segment.

4. In case a message is received indicating that a new mobile device is connected to the network segment, at step 140 the mobile device responds to this message with a similar message that may include the same message identifier and all of the fields listed in the feedback description. Thus, each newly connected mobile device receives information on all mobile devices available in this network segment, and each mobile device located in this network segment receives information on all newly connected mobile devices.

5. When the mobile device receives the message from step 2 above, the receiving mobile device saves (to its memory) information on the matching of the message sending mobile device identifier to the IP address of the sending mobile device. The message sending mobile device identifier information is further used in the establishment of direct connections between mobile devices.

### Detection of Mobile Devices Located in Different Network Segments

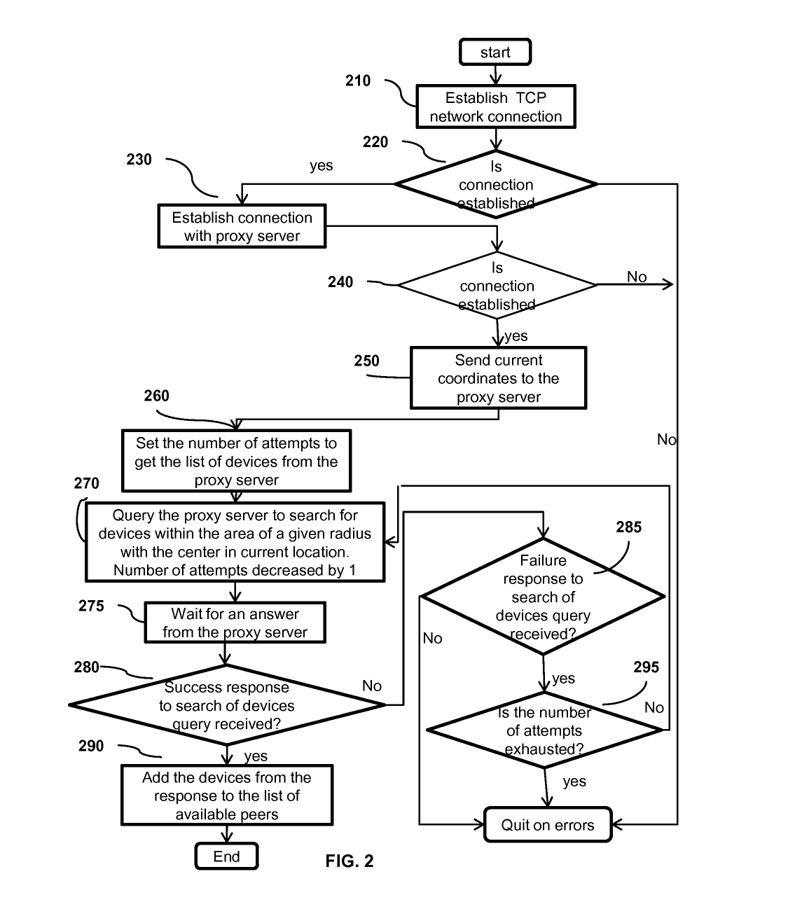

In embodiments a specialized intermediate server is used to search for mobile devices located in different network segments. The specialized server is also used to establish a connection with mobile devices that do not support connection by IEEE 802.11 family protocols. The following method as illustrated in the flowchart of FIG. 2, and may be used to search for mobile devices by means of the intermediate server:

1. At step 210, a transport connection is established to the network, which allows establishing TCP/IP protocol connection to the server. Transport connection may be established using any of the protocols supported by the mobile device and allowing establishment of TCP/IP protocol connection. For example, these may be protocols of the IEEE 802.11 family, GPRS, CDMA protocols, etc. Network parameters are configured in this case by any of the methods that are supported by the mobile device.

2. At step 220, verification is made of whether the connection initiated at step 210 was established successfully. After a successful verification at step 220, at step 230 the first mobile device connects to the intermediate server using the TCP/IP protocol and registers on the intermediate server. The method of connection to the intermediate server, and the registration on the intermediate server are illustrated in FIG. 4.

3. At step 240, verification is made as to whether the connection described at step 230 was established successfully. In case of a successful connection, at step 250 the mobile device sends to the server a message containing the mobile device's geographical coordinates, the list of identifiers of applications running on the mobile device and a set of properties associated with each of these applications. The coordinates may include geographical latitude and longitude in degrees, altitude above sea level in meters and the extent of longitude and latitude identification error in meters. The list of application identifiers may be in the form of a list of text strings.

4. After the message is successfully sent at step 250, the mobile device sets a counter of server response retrieval attempts (step 260), and sends a message to the server containing a query to search for other mobile devices, and decreasing the number of attempts by one (step 270). The message may include a radius in meters for the search of mobile devices relative to the current location. The message also comprises the identifier of the application that is supposed to be launched in the sought-for mobile devices. The application identifier is represented by a single text string.

5. After the message is successfully sent at step 270, at step 275 the mobile devices wait for a response from the server. The server may respond either with a success message (processed at step 280) or a failure message (processed at step 285). The success message includes a list of the above-type response (as described in step 4) from mobile devices meeting the search query sent at step 270. The failure message comprises the error code and error text description.

6. After a success message is received at step 280, at step 290 the mobile device saves to its memory the list of identifiers of devices from this message. The IP addresses for these device identifiers are not saved in contrast to step 160, FIG. 1. The non-saving of the IP addresses is further used as a way to determine if the mobile device with a given device identifier is available through the server, but not directly in the same network segment.

7. In case a failure message is received at step 285, at step 295 the mobile device verifies whether the number of attempts to receive the list of necessary devices from the server is exhausted. If the number of these attempts is exhausted, the method illustrated in FIG. 2 terminates. Otherwise, the method returns to step 270.

### Application Interaction Subsystem

In an embodiment, the purpose of the application interaction subsystem is to provide access to features of the system node for applications running on a mobile platform. The primary goal of the service is to publish the interface and translate function calls of this interface to internal events of the system node.

In order to perform the functions of the application interaction subsystem, the system node requires at least the following queries to be processed by the applications:

a. an application connection or disconnection to/from the system node;

b. a network connection establishment and termination;

c. a selection of an array of available system nodes located at a given distance and controlled by a given set of applications;

d. retrieval of identifiers and properties of applications running in a given system node; and

e. data transfer to a specified device and receipt of incoming data.

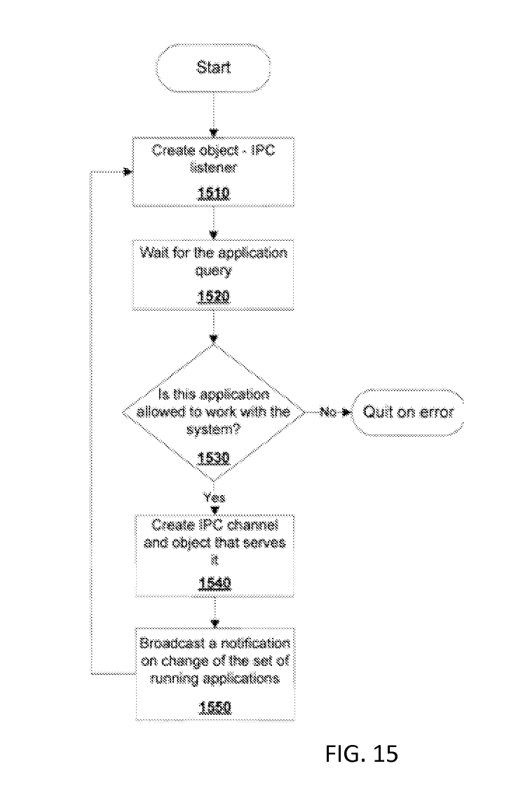

Possible embodiments of the application interaction subsystem greatly depend on capabilities of a mobile device. In some cases, mobile devices allow several processes running simultaneously. For processes running simultaneously, it is possible that the system and the application will be run by different processes. For processes running simultaneously, a possible embodiment of the method of inter-process data transfer channel (IPC channel) establishment on the side of the system may look like the one illustrated in FIG. 15 described as follows:

1. The system creates a common communication channel for application queries (1510). Depending on platform capabilities, the communication channel may be a network socket with a fixed port number or a named pipe with a common name. The system then waits for application queries through this communication channel (1520).

2. In a connection query, an application identifies itself, for example by means of a unique name. At this step, the system may refuse to process the application (1530).

3. If the application was successfully identified, a separate inter-process channel is created for the application. The separate inter-process channel may be used for information exchange between the application and the system. In addition, an object is created at this step that controls data transfer on the side of the system (1540).

4. Since the set of applications running on the mobile device has changed, either the system server or all mobile devices located in the same network segment may be notified of the changes with regard to the set of applications running on the mobile device.

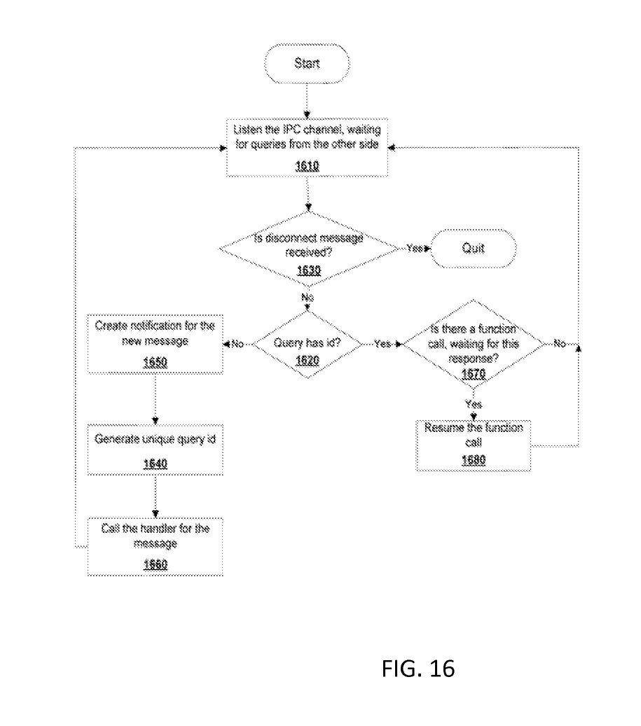

A possible embodiment for the processing of incoming connections through the created interaction channel between the system and the application is illustrated in FIG. 16. The method of FIG. 16 may be used both on the application side and on the system side, as follows:

1. The inter-process channel is monitored (1610), and if a message is received, the message is analyzed. If the received message is a device disconnect message (1630), the method terminates.

2. Verification may be made as to whether the incoming message contains a unique identifier (1620). The unique identifier implies that the incoming message is a part of a previously started interaction that had been terminated before this message was received. In this case, a handler function is searched for to handle messages by message identifiers (1670). If such a function is found, the message is passed to it for processing (1680). Otherwise, it is considered that another side had terminated interaction before the message was received (for example, in case of a timeout).

3. If the identifier in the incoming message is equal to zero, the incoming message starts a new interaction (1650). A unique identifier (1640) is generated and a handler for this message is called (1660).

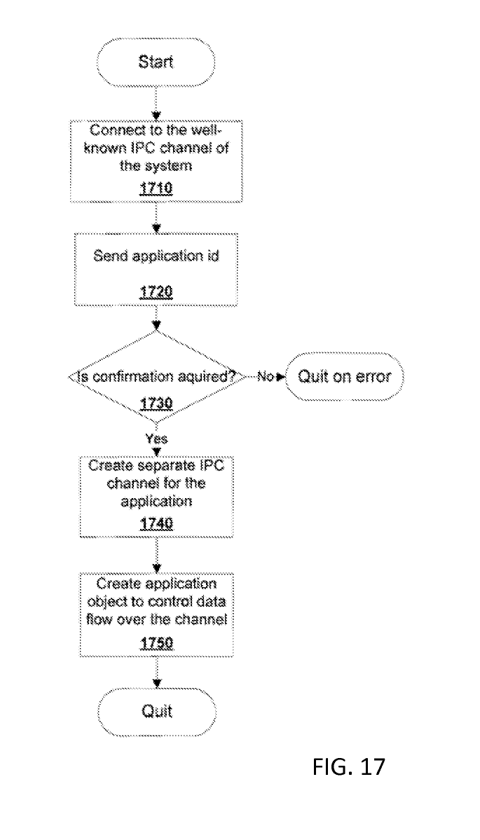

A possible embodiment of application activities aimed to connect to the system based on the method shown in FIG. 15 is illustrated in FIG. 17.

### Application Properties Publication Subsystem

The subsystems described above enable both the finding of mobile devices within a given radius and controlled by a given application, and to transfer information between devices. However, such functionality is often not enough to establish full-scale cooperation of applications running on mobile devices. The lack of establishment of full-scale cooperation is due to the fact that each application may formulate a set of properties that refine search criteria. The application properties publication subsystem is included in system embodiments in order to enable an application to search for mobile devices by its own specific criteria.

For the application properties publication subsystem mechanism to function properly, it may be desirable for the system to provide to the application the following features:

a. a publication of application properties;

b. a change of application property values;

c. the possibility to use values of published properties to refine a mobile device search.

In some embodiments, a property may be represented by the “name-value” pair where both the name and the value are described by a character string. Subsequently, a set of such pairs is associated with each application identified by a certain identifier.

Publication of application properties within one network segment may be carried out by sending a broadcast query, in case application properties are described as stated above. This query may be sent immediately after a device is connected to the network segment or when performing the query for the first search of devices.

The publication of application properties for different network segments may require the sending of application properties to the server for their further use. Depending on the system embodiment, the sending of application properties may happen both at the moment of mobile device registration on the server, and by means of a special query after connecting to the server.

A change of application properties includes at least the forwarding of the query containing application identifier, and a set of properties, for example in the form of the above-mentioned set of “name-value” type strings. In the case where the mobile device runs in one network segment, the query may be a broadcast; otherwise, if the mobile device works with several network segments, the query may be sent to the server.

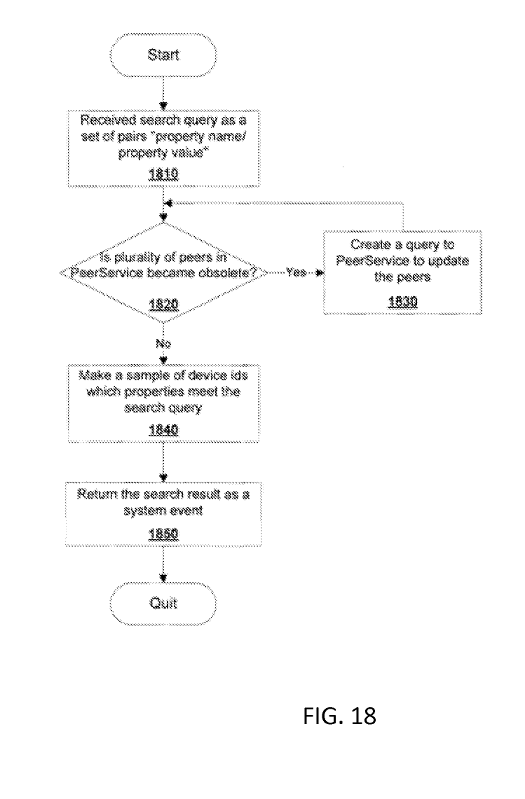

FIG. 18 shows an embodiment of a refined search by a subset of values.

### Server Component of the System

In embodiments an intermediate server is an independent specialized system block. The purpose of the server component is to ensure interaction between mobile devices located outside a single network segment. The server component emulates the operating mode characteristic for direct connection between devices, over the Transmission Control Protocol/Internet Protocol (TCP/IP) family of protocols. To perform this function, it may be desirable that the server component supports the following features:

a. Registration of a mobile device and the list of applications running on the mobile device, wherein each of the mobile's applications may be associated with a certain set of properties;

b. Establishment of a communication channel between any two mobile devices registered on the server;

c. Data transfer between mobile devices registered on the server;

d. Retrieval of an array of mobile devices belonging to a given area upon a request from a device.

The server features (a-d) may be implemented on the basis of the architecture described above in the discussion of the separate set of subsystems. Some of the services implemented on mobile devices are used on the server without any changes. The services may include: a subsystem interaction service and a configuration service. The features of some services performing the functions for the system running on mobile devices may be changed. The services may include:

a. a subsystem for detection of devices located at a given distance from the specified device and controlled by applications from a given set;

b. a subsystem for receiving/transmitting information from/to a specified device.

### Server Subsystem of Receiving/Transmitting Information from/to a Specified Device

In an embodiment, one purpose of the server subsystem is as follows. A system running on mobile devices arranges information transfer between mobile devices. However, in contrast to the earlier described embodiment for transferring data between mobile devices, mobile devices are registered with a server, a communication channel is established and an information transfer between devices registered on the server is arranged.

As mentioned before, each mobile device in the system may be identified by a unique string—e.g., a device name. An example of such a name is IMEI (International Mobile Equipment Identity) code. When a mobile device is connected to the server component, the mobile device transfers the mobile device's unique identifier, which allows the storing of the list of active devices on the server. The process of registration on the server from the client device perspective is illustrated in FIG. 4.

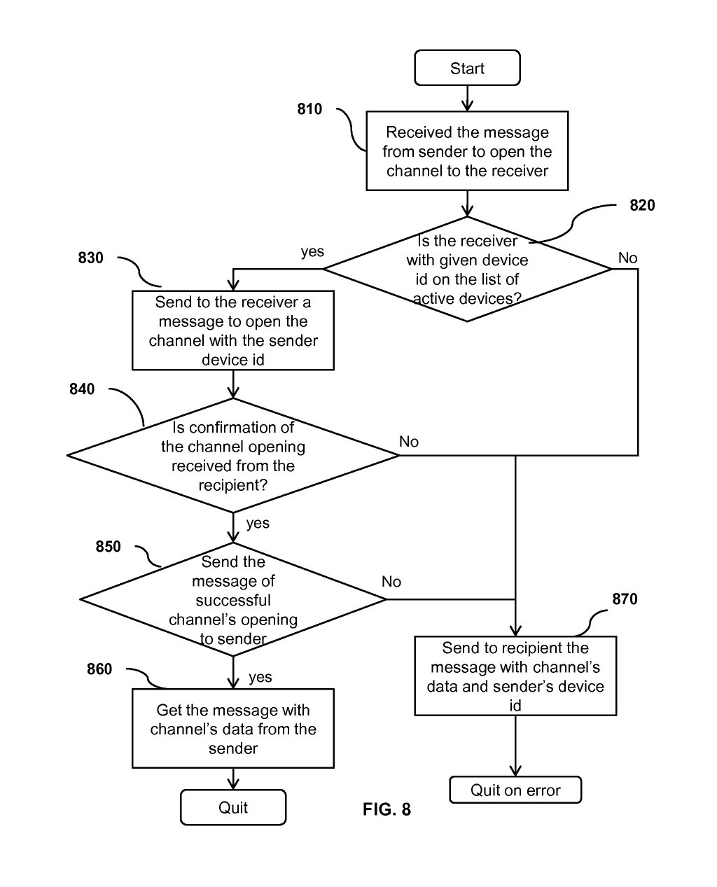

A possible embodiment of channel creation procedure between mobile devices registered on the server is illustrated in FIG. 8. It is assumed that before starting to work with the server, the sender has established a connection with the server by means of the network connection establishment subsystem, for example using the method illustrated in FIG. 4 as follows:

1. The service waits for a message on channel opening initialization with a specified device (810 in FIG. 8). The message may contain as its parameters both the identifier of the mobile device opening the channel and the identifier of the device that is to be connected to.

2. If the identifier of the device to be connected to is in the list of active devices on the server (block 820 in FIG. 8), the method passes to step 3 here. If this device is not in the list, the method passes to step 6 here.

3. A unique channel identifier is generated and a message is sent to the required mobile device about the establishment of a communication channel (step 830 in FIG. 8). If the message is sent successfully, the method passes to step 4 here, otherwise—to step 6.

4. If a confirmation about channel opening on the device side is received (850 in FIG. 8), control is then passed to step 5 here, otherwise—to step 6.

5. A communication channel is opened (860 in FIG. 8), and a notification about the successful channel opening is sent to the mobile device that initiated the creation of the communication channel. The method terminates successfully.

6. A message is sent to the device that initiated the channel opening about the impossibility of data transfer (870 in FIG. 8), and the method terminates with an error.

After the channel is opened, the server component is used to ensure data transfer in the established communication channel. It is assumed that the mobile device that initiated data transfer runs according to the procedure illustrated in FIG. 6.

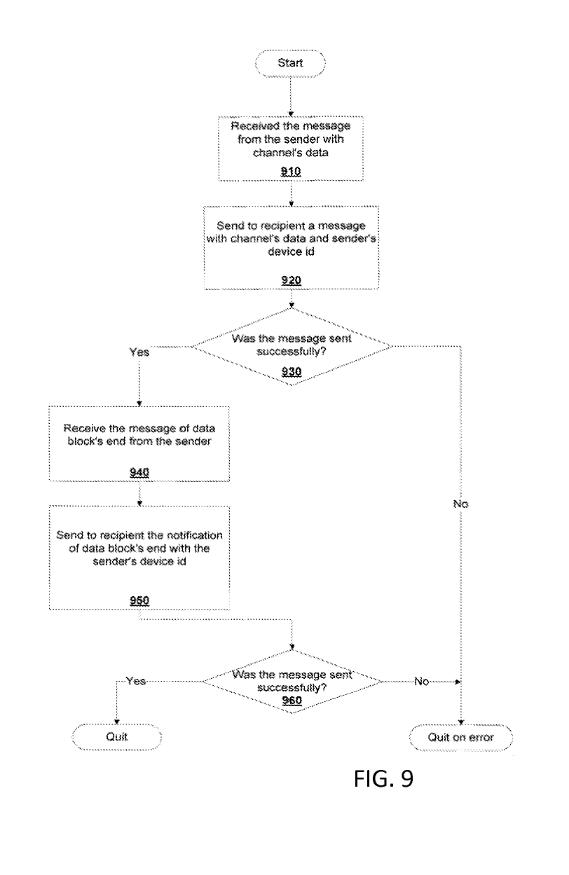

Following a successful opening of the channel, the sender starts the data transfer process. In order to do so, sending mobile device sends a message with channel data to the address of the server. The structure of this message as well as the detailed method of data transfer in a channel is given in the description of the data transfer subsystem (FIG. 6). A possible embodiment of the data transfer procedure in the server component is illustrated in FIG. 9, as follows:

1. At step 910, the server receives a message from the sender with channel data, and at step 920 the sending mobile forwards the message to the receiver indicating the identifier of the sender's device.

2. In the event at step 930, the message is sent successfully, the server proceeds to wait for the next messages from both devices involved in data transfer.

3. At the next step, the sender may send either a message with the next portion of data to the receiver's address or a logical data block end message. FIG. 9 only illustrates a situation with the logical data block end, since when transferring the next portion of data the method of the server does not change and includes the repetition of steps 910, 920, and 930.

4. In the event at step 940 a notification of the logical data block end is received from the sender, at step 950 the server forwards this notification together with messages with channel data to the receiver. In the case of a successful transfer at step 960, channel data is considered transferred in full and the method of server-through data transfer between the devices terminates.

Each incoming message from the sender is forwarded to the receiver's address with an indication of the receiver's device identifier. Thus, data transfer is transparent both for the sender and the receiver irrespective of the availability of a proxy server.

### Server Subsystem of Detection of Devices Located at a Given Distance from the Specified Device and Controlled by Applications from a Given Set

The server subsystem for detection of devices performs the same function as the corresponding subsystem on mobile devices, i.e., the retrieval of a subset of mobile devices located at a given distance from the specified device and having at least one running application from a given set.

The disclosed embodiment of the server subsystem for detection of devices located at a given distance from the specified device assumes that the mobile device has established a connection with the server (FIG. 4), and uses the detection procedure illustrated in FIG. 2 as follows:

1. The server subsystem receives a query for conducting a search for mobile devices from one of the system devices. The search query may contain the list of application identifiers and associated properties, geographical coordinates of the device sending the query, and a description of the desired search area. For example, a desired search area may be a circular radius with the center in the current location of the querying device.

2. In accordance with the search query parameters, the system searches the list of active devices for mobile devices that are located in the given area. In some cases, a search may fail, for example, when the user incorrectly set the search area (negative or too large a radius, etc.). In the event the search parameters are incorrect, the device receives a search failure message.

3. If the search is successful, search results are sent to the device.

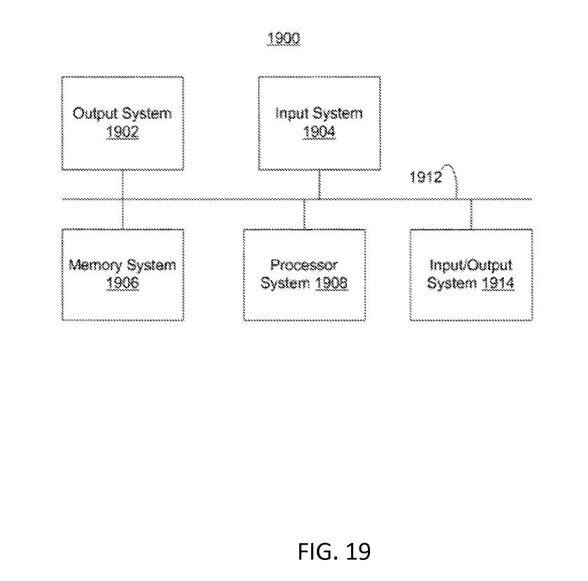

FIG. 19 shows a block diagram of an embodiment of a device 1900 used in this specification. The device 100 may include output system 1902, input system 1904, memory system 1906, processor system 1908, communications system 1912, and input/output device 1914. In other embodiments, device 1900 may include additional components and/or may not include all of the components listed above.

Device 1900 is an example of a device that may be used for a mobile device, server, and/or other devices of this specification.

Output system 1902 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. If device 1900 is a mobile device output system 1902 may include software and/or hardware (e.g., an antenna and transmitter) for wirelessly sending data.

Input system 1904 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. If device 1900 is a mobile device output system 1902 may include software and/or hardware (e.g., an antenna and receiver) for wirelessly sending data.

Memory system 1906 may include, for example, any one of, some of, any combination of, or all of a long term storage system, such as a hard drive; a short term storage system, such as random access memory; a removable storage system, such as a floppy drive or a removable drive; and/or flash memory. Memory system 1906 may include one or more machine-readable mediums that may store a variety of different types of information. The term machine-readable medium is used to refer to any medium capable carrying information that is readable by a machine. One example of a machine-readable medium is a computer-readable medium. If device 1900 is a server, memory system 1900 may store server software and one or more applications for searching for, communicating with, and establishing connections between the other devices of the system. If device 1900 is a server, memory system 1900 may store server software and one or more applications for searching for, communicating with, and establishing connections between the other devices of the system. If device 1900 is a mobile device, memory system 1900 may store one or more applications for searching for, communicating with, and establishing direct connections between the other devices of the system and software for communicating with the server. If device 1900 is a mobile device, memory system 1900 may store a multiplicity of different routines for connecting to different types of devices. If device 1900 is a mobile device, memory system 1900 may store a user interface that may be used for transferring data to and/or from another device that may be used no matter the method of establishing a connection with the other device.

Processor system 1908 may include any one of, some of, any combination of, or all of multiple parallel processors, a single processor, a system of processors having one or more central processors and/or one or more specialized processors dedicated to specific tasks.

Communications system 1912 communicatively links output system 1902, input system 1904, memory system 1906, processor system 1908, and/or input/output system 1914 to each other. Communications system 1912 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 1914 may include devices that have the dual function as input and output devices. For example, input/output system 1914 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1914 is optional, and may be used in addition to or in place of output system 1902 and/or input device 1904. Input output system 1914 may include an antenna and/or other hardware that is used for both sending and receiving messages.

In an embodiment, the invention also includes one or more machine-readable mediums in form of a computer program product that may store a variety of different types of information. The term machine-readable medium is used to refer to any medium capable of carrying information that is readable by a machine. One example of a machine-readable medium is a computer-readable medium. The computer program product can carry instructions for carrying out the method of connecting one or more computing devices as described above.

Each embodiment disclosed herein may be used or otherwise combined with any of the other embodiments disclosed. Any element of any embodiment may be used in any embodiment.

While the communication method and system has been described by way of example and in terms of the specific embodiments, it is to be understood that the communication method and system is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Aspects, features, techniques, and advantages described herein are not all-inclusive, and, in particular, many additional aspects, features, techniques and advantages will be apparent to one of ordinary skill in the art in view of the figures and the above description of the preferred embodiments of the present invention.

1. A method for exchanging information between a first computing device and a second computing device, said method comprising:
a. facilitating selection of one or more parameters by a user of said first computing device;
b. searching among a plurality of computing devices to identify one or more computing devices based on said one or more parameters, wherein said searching is carried out using at least one of:
i. a short-range communication standard, when at least one of said plurality of computing devices are in a network segment that is same as a network segment of said first computing device, and
ii. an intermediate server, when at least one of said plurality of computing devices are in a network segment different from said network segment of said first computing device;
c. providing said user with a list of said one or more computing devices resulting from said searching;
d. facilitating said user to select said second computing device, from said list of said one or more computing devices, for exchanging said information; and
e. establishing a connection between said first computing device and said second computing device, said connection facilitating exchange of said information between said first computing device and said second computing device, and further wherein said connection is established using:
i. a short-range communication standard, when said second computing device is in a network segment that is same as said network segment of said first computing device, and
ii. an intermediate server, when said second computing device is in a network segment different from said network segment of said first computing device.

2. The method of claim 1 further comprising retrieving identifiers of one or more applications running on said second computing device.

3. The method of claim 1 further comprising registering of said one or more computing devices on said intermediate server, when said one or more computing devices are in a network segment different from said network segment of said first computing device.

4. The method of claim 1, wherein said list of said one or more computing devices comprises information relating to at least one of a computing device identifier, a user alias, one or more applications running on corresponding computing device and geographical coordinates of said one or more computing device.

5. The method of claim 4, wherein said information corresponding to said one or more computing devices is periodically updated on said intermediate server.

6. The method of claim 4, wherein said information corresponding to said one or more computing devices is updated on said intermediate server upon a substantial change in geographical position of said one or more computing devices.

7. The method of claim 1 further comprising displaying a user interface on said first computing device for enabling said user to select said second computing device from said list of said one or more computing devices, wherein said user interface displayed is same irrespective of said connection being established via said short-range communication standard or said intermediate server.

8. The method of claim 1, wherein said short-range communication standards include at least one of an IEEE 802.11 communication standard, a Bluetooth connection, a peer to peer connection, and an ad-hoc connection.

9. The method of claim 1, wherein said searching is carried out by geographical coordinates based on a geographical proximity, as selected by the user of said first mobile device, when said first computing device and said second computing device are in different network segments.

10. The method of claim 1, wherein said searching is carried out by sending out broadcasts packets form said first computing device, when said first computing device and said second computing device are in the same network segment.

11. A computer program product for use in a first computing device, said computer program product configured to enable information exchange between said first computing device and a second computing device, said computer program product comprising at least one computer-readable storage medium having computer-readable program code portions stored therein, said computer-readable program code portions comprising instructions for:
a. facilitating selection of one or more parameters by a user of said first computing device;
b. searching among a plurality of computing devices to identify one or more computing devices based on said one or more parameters, wherein said searching is carried out using at least one of:
i. an IEEE 802.11 communication standard, when at least one of said plurality of computing devices are in a network segment that is same as a network segment of said first computing device, and
ii. an intermediate server, when at least one of said plurality of computing devices are in a network segment different from said network segment of said first computing device;
c. providing said user with a list of said one or more computing devices resulting from said searching;
d. facilitating said user to select said second computing device, from said list of said one or more computing devices, for exchanging said information; and
e. establishing a connection between said first computing device and said second computing device, said connection facilitating exchange of said information between said first computing device and said second computing device, and further wherein said connection is established using:
i. an IEEE 802.11 communication standard, when said second computing device is in a network segment that is same as said network segment of said first computing device, and
ii. an intermediate server, when said second computing device is in a network segment different from said network segment of said first computing device.

12. The computer program product of claim 11 further comprising instructions for retrieving identifiers of one or more applications running on said second computing device.

13. The computer program product of claim 11 further comprising instructions for registering of said one or more computing devices on said intermediate server, when said one or more computing devices are in a network segment different from said network segment of said first computing device.

14. The computer program product of claim 11, wherein said list of said one or more computing devices comprises information relating to at least one of a computing device identifier, a user alias, one or more applications running on corresponding computing device and geographical coordinates of said one or more computing device.

15. The computer program product of claim 14, wherein said information corresponding to said one or more computing devices is periodically updated on said intermediate server.

16. The computer program product of claim 14, wherein said information corresponding to said one or more computing devices is updated on said intermediate server upon a substantial change in geographical position of said one or more computing devices.

17. The computer program product of claim 11 further comprising instructions for displaying a user interface on said first computing device for enabling said user to select said second computing device from said list of said one or more computing devices, wherein said user interface displayed is same irrespective of said connection being established via said short-range communication standard or said intermediate server.

18. The computer program product of claim 11, wherein said short-range communication standard include at least one of an IEEE 802.11 communication standard, a Bluetooth connection, a peer to peer connection, and an ad-hoc connection.

19. The computer program product of claim 11, wherein said searching is carried out by geographical coordinates based on a geographical proximity, as selected by the user of said first mobile device, when said first computing device and said second computing device are in different network segments.

20. The computer program product of claim 11, wherein said searching is carried out by sending out broadcasts packets form said first computing device, when said first computing device and said second computing device are in the same network segment.
